(19) United States
(12) Patent Application Publication
(10) Pub. No.: US 2018/0345591 A1
(43) Pub. Date: Dec. 6, 2018

(54) METHOD OF CREATING LARGE COMPLEX COMPOSITE PANELS USING CO-CONSOLIDATION OF THERMOPLASTIC MATERIAL SYSTEMS

(71) Applicant: The Boeing Company, Chicago, IL (US)

(72) Inventors: Kenneth D. Cominsky, Mukilteo, WA (US); Trevor Shane McCrea, Everett, WA (US); David Eric Gideon, Edmonds, WA (US); Bernhard Dopker, Bellevue, WA (US); Paul Diep, Bothell, WA (US); Julie Frances Murphy, Puyallup, WA (US); Jordan Seth Erickson, Federal Way, WA (US)

(73) Assignee: The Boeing Company, Chicago, IL (US)

(21) Appl. No.: 15/608,245

(22) Filed: May 30, 2017

(51) Int. Cl. B29C 65/00

(52) U.S. Cl. CPC B29C 66/435; B23K 20/02

(57) ABSTRACT

A method of constructing a large, complex composite panel involves connecting smaller compression molded thermoplastic subpanels, edge to edge using a thermoplastic co-consolidation method. The edges of adjacent subpanels are given complementary surface configurations. The surface configurations are overlapped and heat and pressure are applied to the overlapping surface constructions to co-consolidate the surface constructions in forming a large, composite panel of two or more subpanels.

### FIELD

This disclosure is directed to a method of constructing a large, complex composite panel. The method involves connecting smaller compression molded thermoplastic subpanels, edge to edge using a thermoplastic co-consolidation method. The edges of adjacent subpanels are given complementary surface constructions. The surface constructions are overlapped and heat and pressure are applied to the overlapping surface constructions to co-consolidate the surface constructions in forming a large composite panel from two or more subpanels.

### BACKGROUND

Compression molding is a method of molding in which a pre-heated molding material is first placed into a open, heated mold cavity. The mold is closed and pressure is applied to force the material into contact with all of the mold areas. Throughout the molding process, heat and pressure are maintained until the molding material has cured.

Due to limitations on a size of a mold, compression molding thermoplastic panels can only be performed on smaller panels. Large, complex panel-like structures, such as the horizontal pressure deck of an aircraft, which could take advantage of the properties of thermoplastics, cannot be fabricated as a single piece cost efficiently due to tooling capability.

### SUMMARY

This disclosure pertains to a method of constructing a large, complex composite panel and the composite panel constructed. The method involves constructing the large, complex composite panel from several smaller thermoplastic subpanels.

Several subpanels, for example four subpanels are compression molded of carbon fiber reinforced thermoplastic. Each subpanel is molded with a first surface on one side of the subpanel and a second surface on an opposite side of the subpanel. Each subpanel has a peripheral edge surface extending completely around the subpanel. The peripheral edge surface extends between the first surface and the second surface of each subpanel and separates the first surface and the second surface.

At least a portion of the peripheral edge of each subpanel is then given a constructed surface or a scarf surface. For example, the constructed surface of each subpanel could be a ramped surface or a tapered surface. The constructed surface of each subpanel is complementary to the constructed surfaces of the other subpanels. For example, where the constructed surface is a ramped or tapered surface, the ramped or tapered surfaces have the same angular orientation relative to the first surface of each subpanel and the second surface of each subpanel.

The plurality of subpanels are then brought together with the constructed surfaces of adjacent subpanels engaging against each other. For example, in creating a large, complex composite panel from four subpanels, the four subpanels are brought together in a two-dimensional array with two constructed surfaces of each subpanel engaging against constructed surfaces of two adjacent subpanels.

With the constructed surfaces of the subpanels engaging and overlapping, the areas of the engaging constructed surfaces between adjacent subpanels are heated and pressure is applied to the engaging surfaces. The heating of the engaging constructed surfaces and the pressure applied to the engaging constructed surfaces produces a full melt bond and a co-consolidation between the engaging constructed surfaces. The engaging constructed surfaces of the subpanels are then allowed to cool, forming the large, complex composite panel from the four smaller subpanels.

Additional joining features could then be applied over the areas of the joined constructed surfaces. For example, strips of carbon fiber reinforced thermoplastic could be positioned over the joined constructed surfaces and then heated with pressure applied to co-consolidate the strips to the first surfaces of the joined subpanels and the second surfaces of the joined subpanels.

The features, functions and advantages that have been discussed can be achieved independently in various embodiments or may be combined in yet other embodiments, further details of which can be seen with reference to the following description and drawings.

### BRIEF DESCRIPTION OF THE DRAWINGS

FIG. 1 is a representation of a perspective view of an initial step in the method of creating large, complex composite panels from smaller subpanels of this disclosure.

FIG. 2 is a representation of a further step of the method of this disclosure.

FIG. 3 is a representation of a still further step of the method of this disclosure.

FIG. 4 is a representation of a still further step of the method of this disclosure.

FIG. 5 is a representation of an additional step of the method of this disclosure.

FIG. 6 is a representation of the additional step of this disclosure.

FIG. 7 is a representation of the large, complex composite panel created by the method of this disclosure.

FIGS. 8-11 are representations of cross-sections of different configurations of the constructed surfaces of two adjacent subpanels.

### DETAILED DESCRIPTION

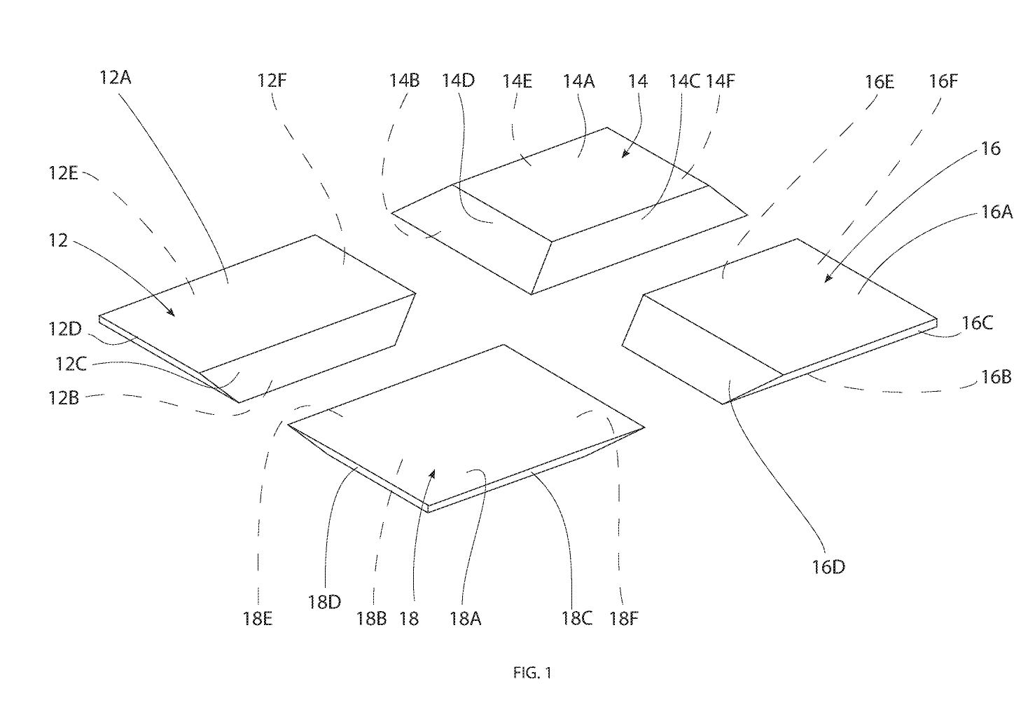

FIG. 1 is a representation of a perspective view of an initial step of the method of constructing a large, complex composite panel using co-consolidation of thermoplastic materials of this disclosure. According to the method, the large panel is constructed from several smaller subpanels. Four subpanels 12, 14, 16, 18 are represented in FIG. 1. However, it should be understood that the large panel 22 could be constructed of fewer than the four subpanels 12, 14, 16, 18 represented in FIG. 1, or more than the four subpanels.

Each of the four subpanels 12, 14, 16, 18 are first formed by compression molding of carbon fiber reinforced thermoplastic to create the subpanels. Each of the subpanels 12, 14, 16, 18 is molded with a first surface 12A, 14A, 16A, 18A on one side of the subpanel and a second surface 12B, 14B, 16B, 18B on an opposite side of the subpanel. As represented in FIG. 1, the first surfaces 12A, 14A, 16A, 18A and the opposite second surfaces 12B, 14B, 16B, 18B are configured as flat, parallel surfaces. However, the first and second surfaces can have different configurations depending on the configuration of the large panel to be constructed from the subpanels. The first surfaces 12A, 14A, 16A, 18A and the second surfaces 12B, 14B, 16B, 18B are also molded with rectangular configurations. However, the configurations of the surfaces could be different depending on the desired configuration of the large panel to be formed from the subpanels.

Each of the subpanels 12, 14, 16, 18 has a peripheral edge surface extending completely around the subpanel. The peripheral edge surface of each subpanel 12, 14, 16, 18 extends between the first surface 12A, 14A, 16A, 18A of each respective subpanel and the second surface 12B, 14B, 16B, 18B of each respective subpanel. The peripheral edge surfaces separate the first surfaces 12A, 14A, 16A, 18A from the respective second surfaces 12B, 14B, 16B, 18B. In the representation of FIG. 1, each of the subpanels 12, 14, 16, 18 has a peripheral edge surface comprised of four constructed or machined surfaces. For example, the first subpanel 12 has four constructed or machined surfaces 12C, 12D, 12E, 12F. The second subpanel 14 has four constructed or machined surfaces 14C, 4D, 14E, 14F. The third subpanel 16 has four constructed or machined surfaces 16C, 16D, 16E, 16F. The fourth subpanel 18 has four constructed or machined surfaces 18C, 18D, 18E, 18F. In the representation of FIG. 1, the constructed or machined surfaces are all flat, tapered or ramped surfaces. The constructed or machined surfaces could have other equivalent configurations, as will be explained.

In the two dimension arrangement of the subpanels 12, 14, 16, 18, opposing constructed surfaces have complementary scarf surface configurations. In the example represented in FIG. 1, opposing, complementary tapered surfaces or complementary flat construction surfaces are parallel to each other and have substantially equal areas. For example, the opposing constructed surfaces 12F and 14D of the respective first subpanel 12 and second subpanel 14 are complementary and will engage in surface contact against each other. The opposing constructed surfaces 12F, 14D represented in FIG. 1 are flat, tapered surfaces. However, the opposing constructed surfaces 12F, 14D could have other, equivalent configurations that will engage in surface contact with each other.

The opposing constructed surfaces 12C, 18E of the respective first subpanel 12 and fourth subpanel 18 are also complementary surfaces that will engage in surface contact with each other. Again, the opposing constructed surfaces 12C, 18E represented in FIG. 1 are flat, tapered surfaces. However, the opposing constructed surfaces 12C, 18E could have other, equivalent configurations that will engage in surface contact with each other.

The opposing constructed surfaces 14C and 16E of the respective second subpanel 14 and third subpanel 16 are also complementary surface that will engage in surface contact with each other.

Furthermore, the opposing constructed surfaces 16D and 18F are complementary surfaces that will engage in surface contact with each other. Although the opposing constructed surfaces 16D, 18F are represented as flat, tapered surfaces, the surfaces could have other equivalent configurations that will engage in surface contact with each other.

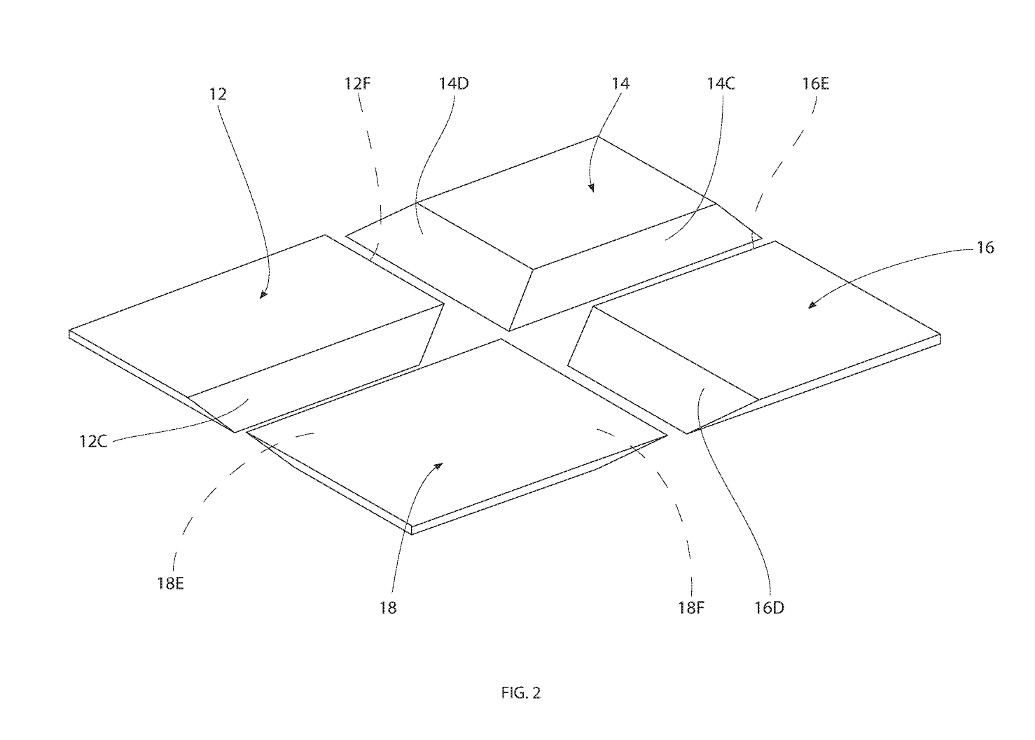

Referring to FIG. 2, a further step in the method of this disclosure is represented. In FIG. 2, each of the subpanels 12, 14, 16, 18 arranged in a single plane and a two-dimensional array are moved or converged toward each other. The first subpanel 12 is moved toward the second subpanel 14 and toward the fourth subpanel 18. The second subpanel 14 is moved toward the first subpanel 12 and toward the third subpanel 16. The third subpanel 16 is moved toward the second subpanel 14 and the fourth subpanel 18.

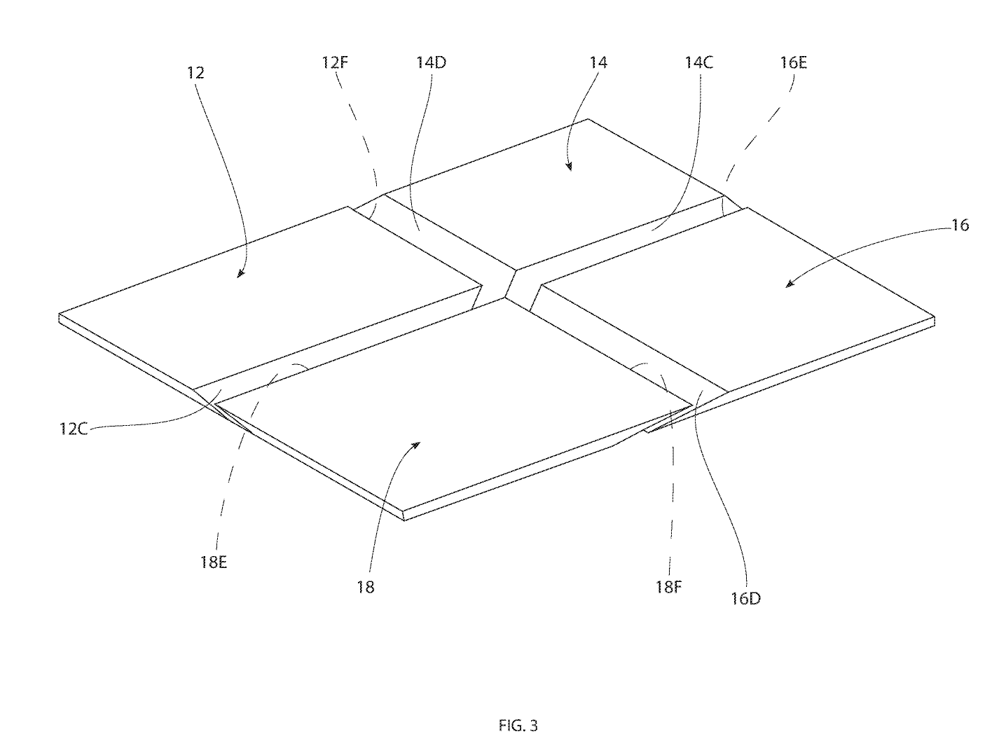

FIG. 3 is a representation of the further, converging movement of the four subpanels 12, 14, 16, 18. As the subpanels 12, 14, 16, 18 are continued to be moved toward each other, the constructed surfaces of the subpanels begin to overlap. For example, the constructed surface 12F of the first subpanel 12 begins to overlap the constructed surface 14D of the second subpanel 14. The constructed surface 14C of the second subpanel 14 begins to overlap with the constructed surface 16E of the third subpanel 16. The constructed surface 16D of the third subpanel 16 begins to overlap with the constructed surface 18F of the fourth subpanel 18. The constructed surface 18E of the fourth subpanel 18 begins to overlap with the constructed surface 12C of the first subpanel 12.

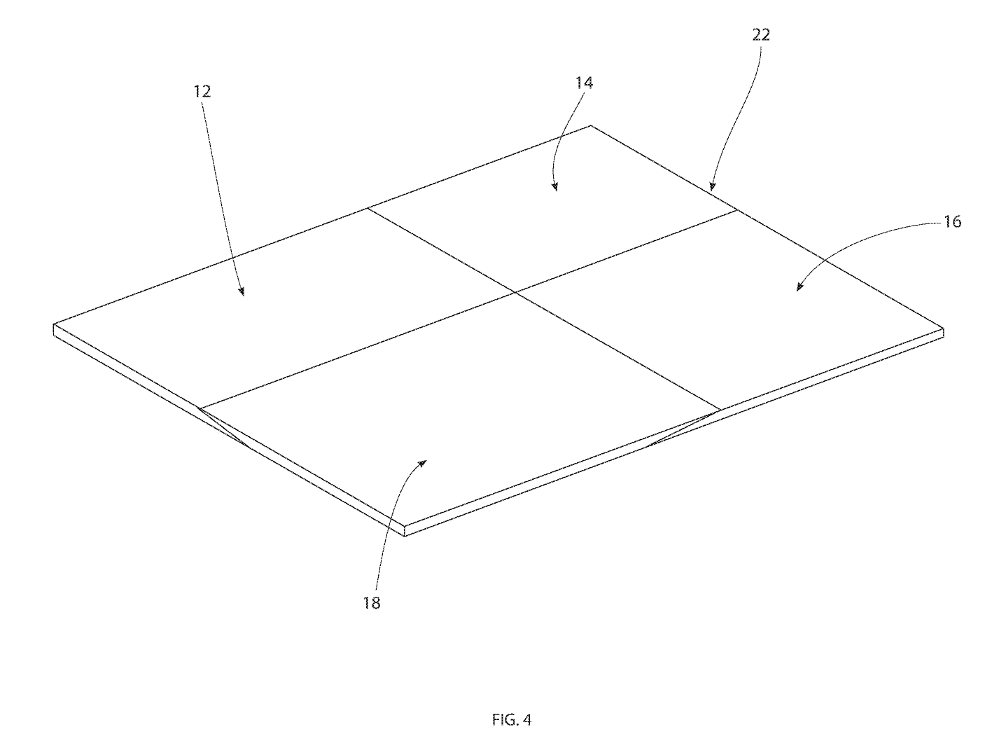

FIG. 4 is a representation of the further converging movement of the four subpanels 12, 14, 16, and 18. In FIG. 4 the constructed surface 12F of the first subpanel 12 and the constructed surface 14D of the second subpanel 14 are engaged in surface engagement. The constructed surface 14C of the second subpanel 14 and the constructed surface 16E of the third subpanel 16 are engaged in surface engagement. The constructed surface 16D of the third subpanel 16 and the constructed surface 18F of the fourth subpanel 18 are in surface engagement. The constructed surface 18E of the fourth subpanel 18 and the constructed surface 12C of the first subpanel 12 are engaged in surface engagement.

The overlapping, engaging constructed surfaces are then heated and pressure is applied to the opposite sides of the overlapping constructed surfaces to press the overlapping constructed surfaces together. Heating of the overlapping constructed surfaces and the pressure to the opposite sides of the overlapping constructed surfaces begins to melt the engaging constructed surfaces and forms a full melt bond and a co-consolidation between the engaging, overlapping constructed surfaces. The engaging, overlapping constructed surfaces of the subpanels 12, 14, 16, 18 are then allowed to cool, forming the large, complex composite panel 22 represented in FIG. 4 from the four subpanels 12, 14, 16, 18.

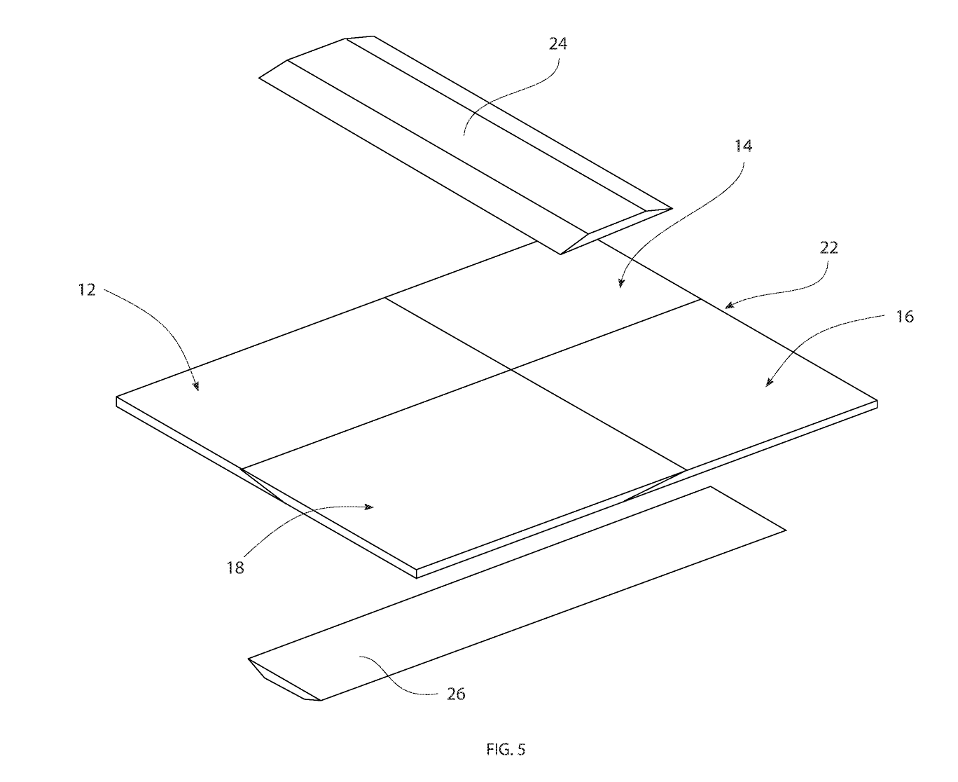

FIGS. 5-7 are representations of additional steps that can be taken to reinforce the large, complex composite panel 22 formed from the four subpanels 12, 14, 16, 18. In FIG. 5, a first splice strap of carbon fiber reinforced thermoplastic 24 is positioned over one side of the large, complex composite panel 22 and a second splice strap 26 of carbon fiber reinforced plastic is positioned on the opposite side of the large, complex composite panel. As represented in FIG. 5, the two splice straps 24, 26 are oriented perpendicular or in a cross-configuration relative to each other.

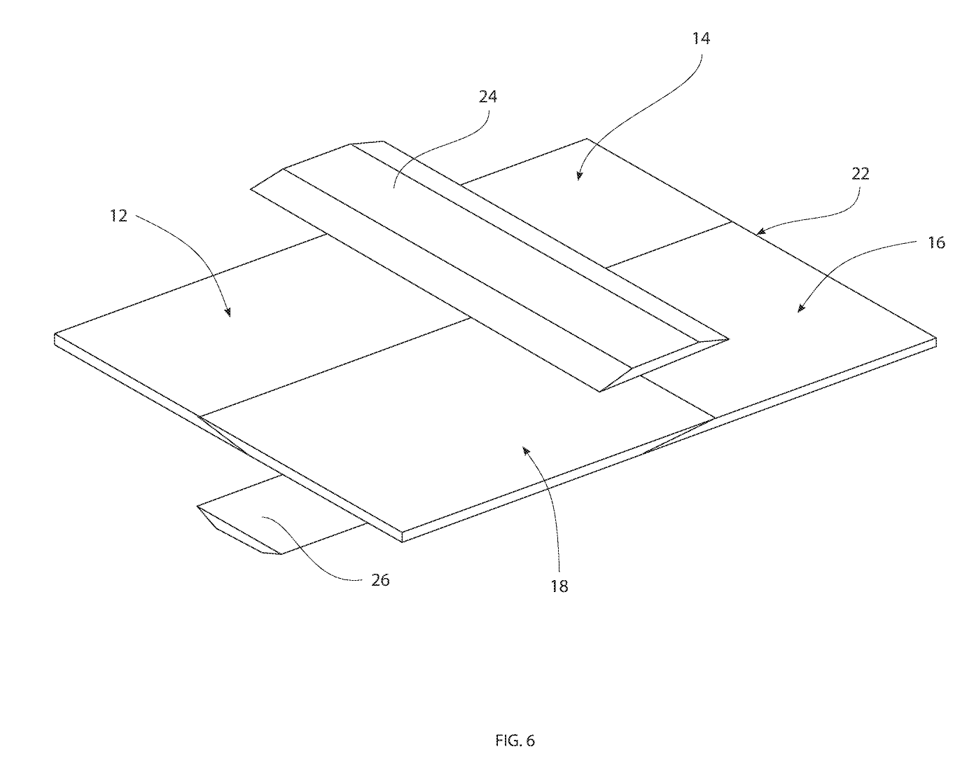

As represented in FIG. 6, the first splice strap 24 is moved toward the one side of the large, complex composite panel 22 and the second splice strap 26 is moved toward the opposite side of the large, composite panel 22.

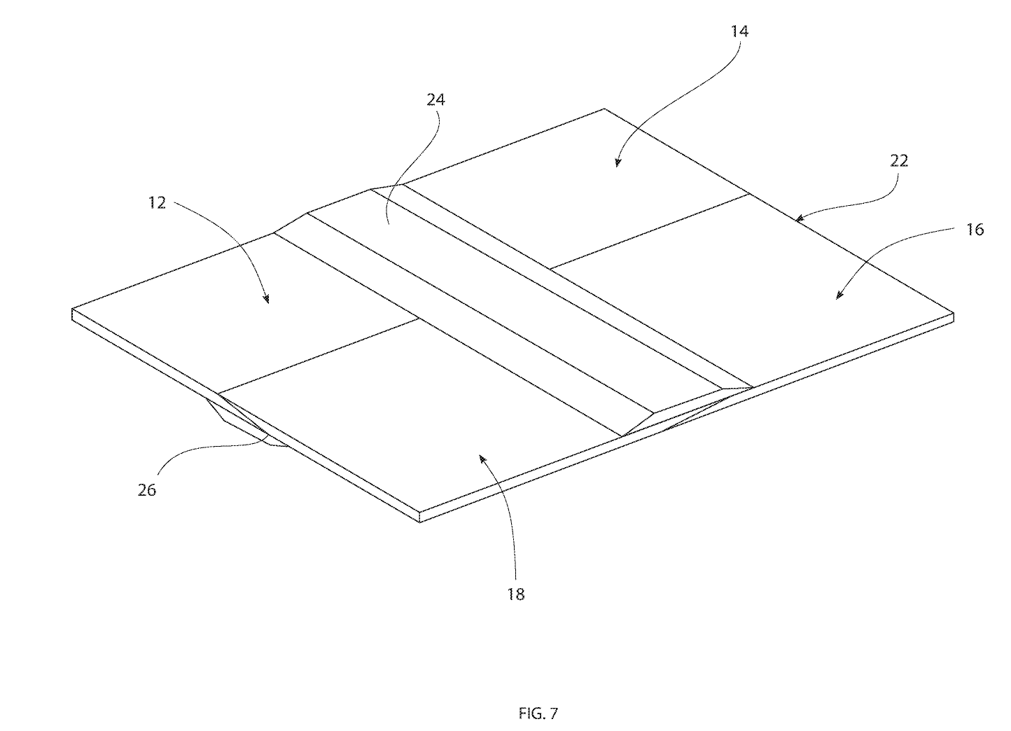

As represented in FIG. 7, the first splice strap 24 is positioned on the large, complex composite panel 22 extending over the co-consolidated joint between the fourth constructed surface 12F of the first subpanel 12 and the second constructed surface 14D of the second subpanel 14 and between the fourth constructed surface 18F of the fourth subpanel 18 and the second constructed surface 16D of the third subpanel 16. The second splice strap 26 is positioned on the opposite side of the large, complex composite panel 22 over the co-consolidated joint between the first constructed surface 12C of the first subpanel 12 and the third constructed surface 18E of the fourth subpanel 18 and the co-consolidated joint between the first constructed surface 14C of the second subpanel 14 and the third constructed surface 16E of the third subpanel 16. With the first splice strap 24 and the second splice strap 26 positioned against opposite sides of the large, complex composite panel 22 as described above, heat is applied to the first splice strap 24 and the second splice strap 26 and pressure is applied to the first splice strap 24 and the second splice strap 26, pressing the strips against opposite sides of the large, complex composite panel. The heat and the pressure applied to the first splice strap 24 and the second splice strap 26 forms a full melt bond and a co-consolidation between the first splice strap 24 and the second splice strap 26 and the opposite sides of the large, complex composite panel 22.

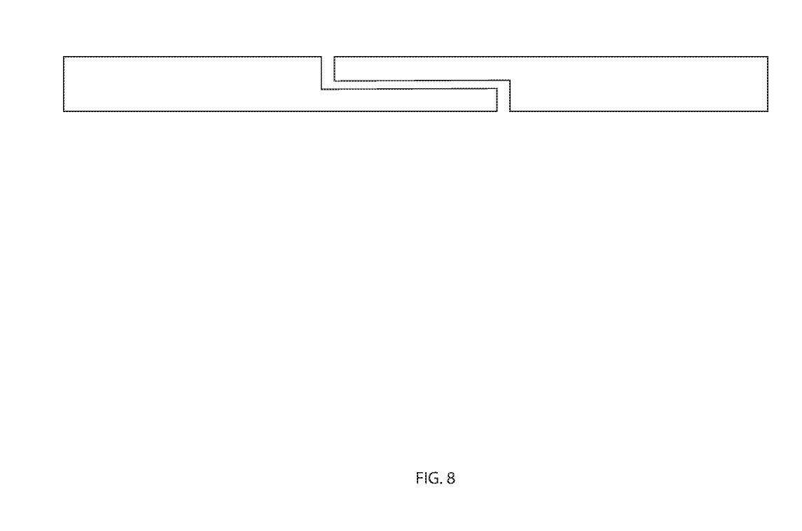

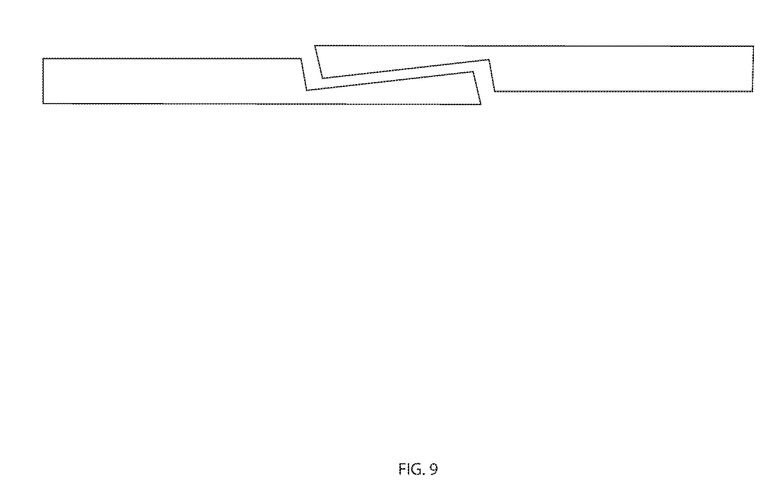

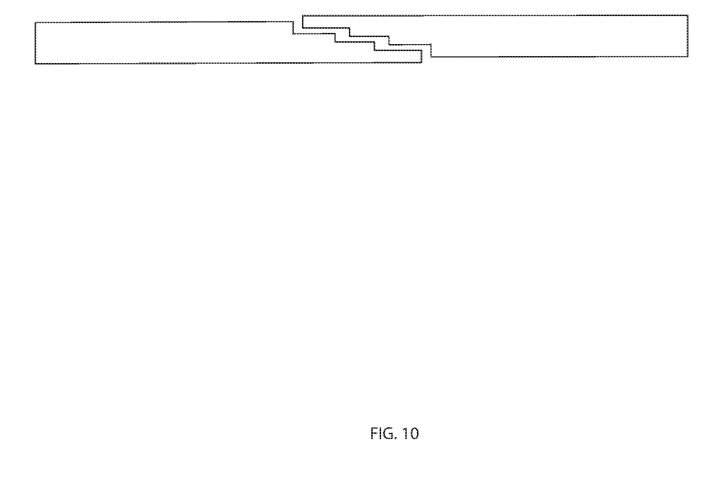

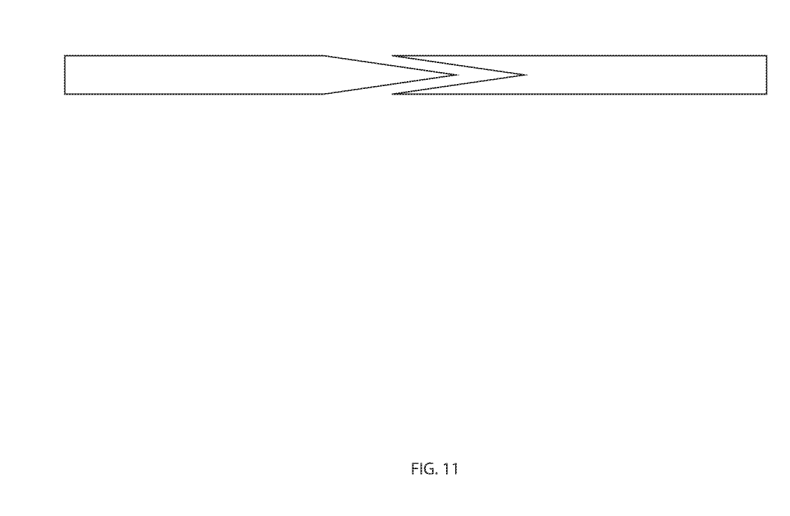

As stated earlier, it is not necessary that the complementary, engaging constructed surfaces of adjacent subpanels have tapered or ramped surfaces as described earlier. FIGS. 8-11 are representations of other, equivalent constructed surfaces configurations that could be employed by adjacent subpanels in producing the full melt bond and the co-consolidation between the engaging constructed surfaces of the adjacent subpanels.

It is important to point out that in each of the above described methods of creating a large, complex composite panel by connecting smaller compression molded thermoplastic subpanels, that using scarf-type edge connections results in the large panel having smooth, continuous upper and lower surfaces. This is not possible in creating a large panel by overlapping or lap-splicing adjacent edges of subpanels to produce the large panel. Such a panel will have stepped upper and lower surfaces at the connection of the adjacent subpanels, which results in eccentricities that are design, stress and integration issues. The method of co-consolidating or welding two overlapped thermoplastic subpanels to form a large panel does not result in a large panel that has smooth, continuous upper and lower surfaces as do the methods of co-consolidating scarf-type edges of subpanels to create a large panel described above.

As various modifications could be made in the construction of the apparatus and its method of operation herein described and illustrated without departing from the scope of the invention, it is intended that all matter contained in the foregoing description or shown in the accompanying drawings shall be interpreted as illustrative rather than limiting. Thus, the breadth and scope of the present disclosure should not be limited by any of the above described exemplary embodiments, but should be defined only in accordance with the following claims appended hereto and their equivalents.

1. A method of constructing a large panel, the method comprising:
producing a first subpanel;
constructing a first constructed surface along an edge of the first subpanel;
producing a second subpanel;
constructing a second constructed surface along an edge of the second subpanel;
positioning the first constructed surface on the first subpanel against the second constructed surface on the second subpanel;
heating the first constructed surface and the second constructed surface; and,
cooling the first constructed surface and the second constructed surface.

2. The method of claim 1, further comprising:
while heating the first constructed surface engaging against the second constructed surface, applying pressure between the first constructed surface and the second constructed surface.

3. The method of claim 2, further comprising:
producing the first subpanel of a thermoplastic; and,
producing the second subpanel of a thermoplastic.

4. The method of claim 3, further comprising:
producing the first subpanel of thermoplastic with carbon fiber reinforcement; and,
producing the second subpanel of thermoplastic with carbon fiber reinforcement.

5. The method of claim 3, further comprising:
overlapping the first constructed surface and the second constructed surface prior to heating the first constructed surface and the second constructed surface.

6. The method of claim 3, further comprising:
constructing the first constructed surface and constructing the second constructed surface as complementary scarf surfaces.

7. The method of claim 3, further comprising:
constructing the first constructed surface and constructing the second constructed surface as complementary tapered surfaces.

8. The method of claim 3, further comprising:
constructing the first constructed surface and the second constructed surface as complementary flat surfaces.

9. The method of claim 3, further comprising:
positioning a splice strap over the engaging first constructed surface and second constructed surface; and,
heating the splice strap positioned over the overlapping first constructed surface and second constructed surface.

10. The method of claim 9, further comprising:
applying pressure to the splice strap while heating the splice strap.

11. The method of claim 3, further comprising:
constructing a further constructed surface along the edge of the first subpanel;
producing a third subpanel;
constructing a third constructed surface along an edge of the third subpanel;
positioning the third constructed surface of the third subpanel against the further constructed surface of the first subpanel;
heating the further constructed surface of the first subpanel and the third constructed surface of the third subpanel; and,
allowing the further constructed surface of the first subpanel and the engaging third constructed surface of the third subpanel to cool and co-consolidate.

12. A method of constructing a large panel, the method comprising;
compression molding a first subpanel of thermoplastic;
constructing a first constructed surface along an edge of the first subpanel;
compression molding a second subpanel of thermoplastic;
constructing a second constructed surface along an edge of the second subpanel;
positioning the first constructed surface in engagement with the second constructed surface;
heating the engaging first constructed surface and second constructed surface; and,
allowing the engaging and heated first constructed surface and second constructed surface to cool, thereby co-consolidating the first subpanel and the second subpanel.

13. The method of claim 12, further comprising:
while heating the first constructed surface engaging against the second constructed surface, applying pressure between the first constructed surface and the second constructed surface.

14. The method of claim 12, further comprising:
compression molding the first subpanel of thermoplastic with carbon fiber reinforcement; and,
compression molding the second subpanel of thermoplastic with carbon fiber reinforcement.

15. The method of claim 12, further comprising:
overlapping the first constructed surface and the second constructed surface when positioning the first constructed surface in engagement with the second constructed surface.

16. The method of claim 12, further comprising:
constructing the first constructed surface and constructing the second constructed surface as complementary scarf surfaces.

17. The method of claim 12, further comprising:
constructing the first constructed surface and constructing the second constructed surface as complementary tapered surfaces.

18. The method of claim 12, further comprising:
positioning a splice strap of thermoplastic over the first constructed surface positioned in engagement with the second constructed surface; and,
heating the splice strap positioned over the first constructed surface positioned in engagement with the second constructed surface.

19. The method of claim 18, further comprising:
applying pressure to the splice strap while heating the splice strap.

20. The method of claim 12, further comprising:
constructing a further constructed surface along the edge of the first subpanel;
compression molding a third subpanel of thermoplastic;
constructing a third constructed surface along an edge of the third subpanel;
positioning the third constructed surface of the third subpanel against the further constructed surface of the first subpanel;
heating the further constructed surface of the first subpanel and the third constructed surface of the third subpanel; and,
allowing the further constructed surface of the first subpanel and the engaging third constructed surface of the third subpanel to cool and co-consolidate.
